(19) United States
(12) Patent Application Publication
(10) Pub. No.: US 2004/0031736 A1
(43) Pub. Date: Feb. 19, 2004

(54) Fluid filtration system with helical filter element

(76) Inventor: John R. Evans, Crewe (GB)

Correspondence Address: CATERPILLAR INC., 100 N.E. ADAMS STREET, PATENT DEPT., PEORIA, IL, 616296490

(21) Appl. No.: 10/640,142

(22) Filed: Aug. 13, 2003

(30) Foreign Application Priority Data
Aug. 19, 2002 (EP) 02255769.8

(51) Int. Cl. B01D 35/02

(52) U.S. Cl. 210/168; 210/457; 210/497.1; 29/896.62

(57) ABSTRACT

A filter element for a fluid filtration system, particularly for piston cooling jets used in reciprocating piston engines, is formed from a length of filter material arranged helically in a substantially tubular form. By applying a torque the length of filter material is resiliently expandable to a fitting position in which opposing longitudinal edges of the length are spaced apart from each other. The filter element is then fitted over a fluid chamber of the filtration system and allowed to retract to a rest position in which the opposing longitudinal edges are close or in contact. In the rest position the filter element surrounds the fluid chamber and covers a fluid inlet of the fluid chamber. The filter element of the invention can be used to apply local filtration, and can be readily removed for cleaning or replacement by reversing the fitting process.

### TECHNICAL FIELD

This disclosure relates to filter elements in fluid filtration systems. It is particularly, but not exclusively, applicable to expandable oil filter elements used within piston cooling jets in reciprocating piston engines.

### BACKGROUND

Piston cooling jets are widely used on reciprocating piston engines, particularly diesel cycle engines, as additional cooling means. They work by directing a jet of oil or other fluid on to the pistons during the operation of the engine. The jets are generally located within the crankcase housing and direct a jet of oil to the underside of the piston. To ensure a precisely located jet of oil, the jets have nozzles that are of a relatively small diameter internal bore. The oil used is generally the lubricating oil contained within the sump of the engine. The oil contained within the sump often contains impurities and particulates. To prevent the jets becoming blocked, the oil may be filtered. Over time, the filters degrade and become blocked and consequently require replacement or cleaning. Prior art filtration methods rely to a large extent on a central filter within the engine's oil circuit or on providing an additional simple paper filter for the cooling jets.

Known filter elements can be difficult to replace or may not provide adequate filtration if the oil circuit is compromised downstream of a central filter. This can happen, for example, if repairs are undertaken in an environment where the risk of contamination from airborne particulates is significant. The present disclosure seeks to provide a filter element that overcomes one or more of these problems.

### SUMMARY OF THE DISCLOSURE

In one aspect, a filter element for a fluid filtration system comprises a length of filter material arranged helically in a substantially tubular form, in which opposing longitudinal edges of the length are in facing relationship. The filter element is resiliently and selectively moveable from a rest position, in which the opposing longitudinal edges are a rest spacing apart from each other, to an expanded fitting position, in which the opposing longitudinal edges are a fitting spacing apart from each other. A fluid filtration system including such a filter element is also disclosed.

In another aspect, a method of fitting a filter element on a fluid filtration system is disclosed, the filter element comprising a length of filter material arranged helically in a substantially tubular form. The method includes the steps of expanding the filter element to an expanded fitting position in which the opposing longitudinal edges of the length are a fitting spacing apart from each other by applying a torque around a central axis of the tubular form in an opposite direction to the filter material's helix. The filter element is then fitted over a wall portion of the fluid filtration system, and allowed to retract to a rest position surrounding the wall portion. In this rest position, opposing longitudinal edges of the length are in facing relationship to each other and a rest spacing apart from each other.

In yet another aspect, a method of manufacturing a filter element comprises the steps of taking a substantially flat piece of filter material having a longitudinal axis and winding it around a central axis to form a substantially tubular filter element. Once wound, the longitudinal axis of the flat piece of filter material is subsequently arranged substantially helically.

Other features and aspects will be apparent from the following description and the accompanying drawings.

### BRIEF DESCRIPTION OF THE DRAWINGS

FIG. 1 is a side view of a filter element according to a first embodiment in a rest position.

FIG. 2 is a side view of the filter element of FIG. 1 in an expanded position.

FIG. 3 is a side view of a piston cooling jet including a fluid filtration system utilizing the filter element of FIG. 1.

FIG. 4 is a part cross sectional side view of the piston cooling jet of FIG. 3.

### DETAILED DESCRIPTION

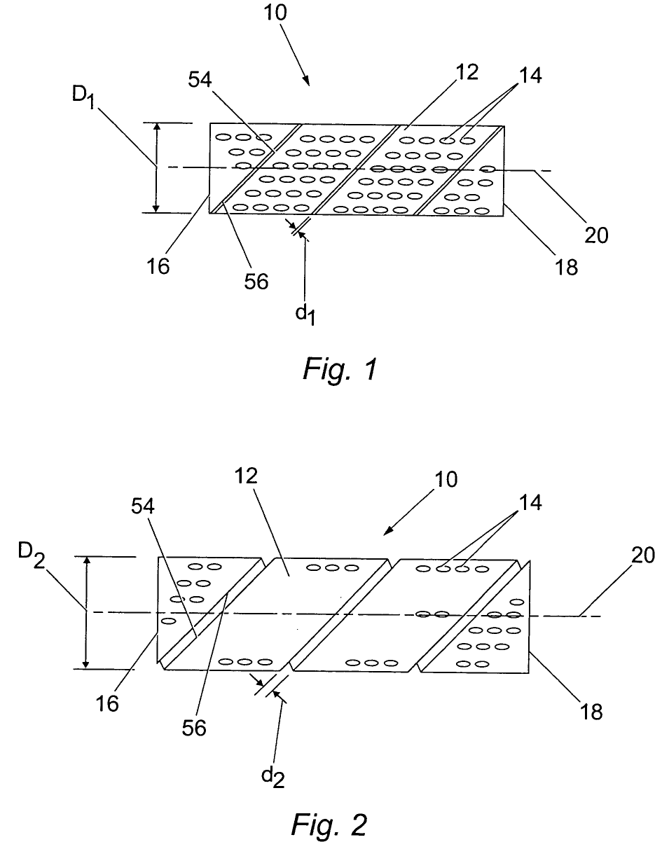

Referring to the drawings, one embodiment will now be described, by way of example only. A filter element 10 is shown in detail in FIGS. 1 and 2. The filter element 10 comprises a length of filter material 12, arranged helically in a tubular form. In this embodiment, the filter material 12 is a metal strip with circular perforations 14 provided through the strip. It is to be understood that the perforations 14 can be of any shape, provided that the dimensions of the perforations are such that particulates having a size greater than the permissible particulate size are prevented from passing through the perforations. It is also to be understood that the metal used may be any suitable for the application, but in this case is steel. Opposing ends 16,18 of the length of filter material 12 are shaped so that when arranged in the tubular form the opposing ends 16,18 of the filter element 10 form planar ends, perpendicular to the central axis 20 of the tubular form. Overall the filter element 10 is therefore cylindrical.

Partly due to the elastic properties of the filter material and partly due to the helical tube form, the filter element 10 displays a resilient character. It is therefore possible to apply a torque to the filter element 10, manually or otherwise, to expand the filter element 10 (see FIG. 2). By doing this the diameter of the filter element 10 can be increased from a rest diameter D1 to a fitting diameter D2. When the torque is released the filter element 10 will return to its rest diameter D1.

The filter element 10 can either be formed by rolling a flat sheet into the helical tube form, or alternatively the filter element 10 may be cut from a tubular section. Other forms of manufacture may also be used to form the filter element 10.

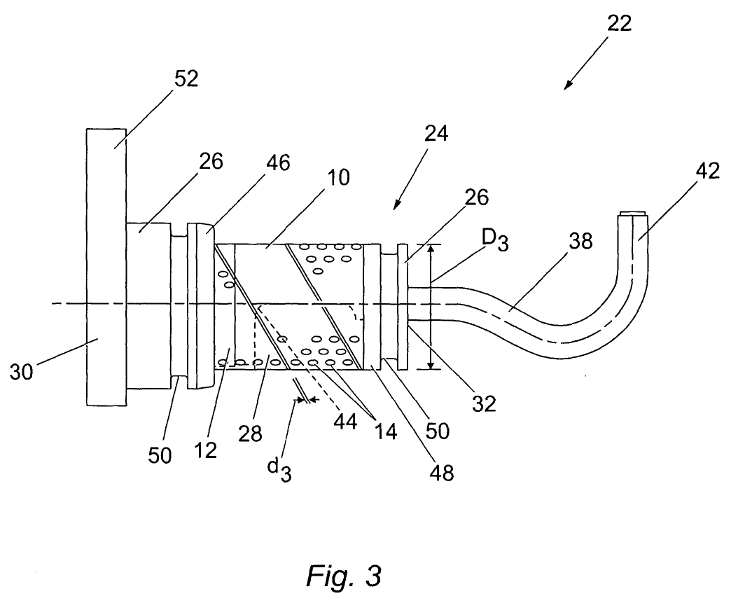

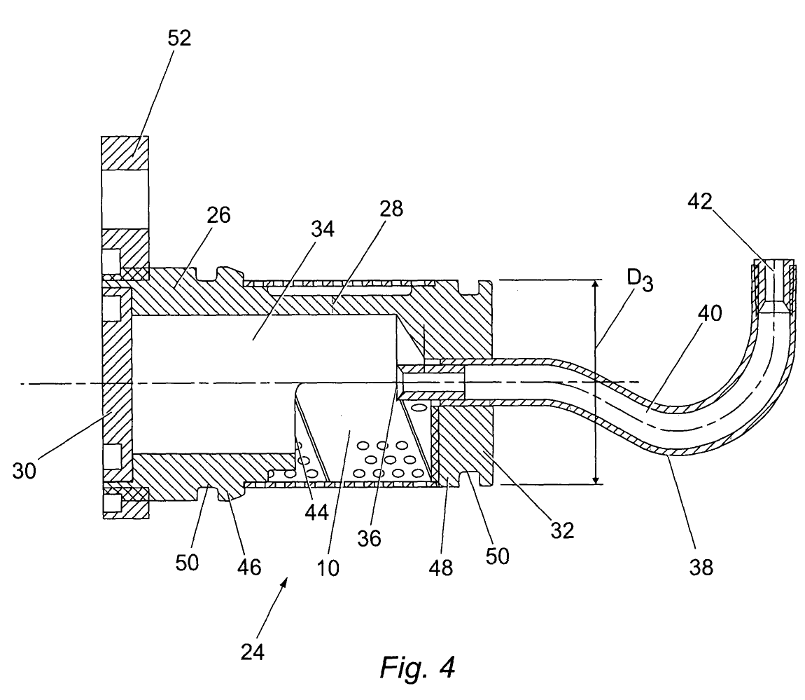

Referring now to FIGS. 3 and 4, there is shown a piston cooling jet generally referred to as 22, including a fluid filtration system 24 utilizing a filter element 10. The piston cooling jet 22 includes a cooling jet housing 26. The cooling jet housing 26 has a substantially cylindrical side wall 28, a first end wall 30 and a second end wall 32 defining therein a fluid chamber 34. A tapered fluid outlet 36 is located in the first end wall 30. A jet nozzle 38 extends from the fluid outlet 36. The jet nozzle 38 has an internal passageway 40 and terminates in an internally tapered jet nozzle outlet 42. It will be understood that the shapes of the fluid outlet 36, jet nozzle outlet 38 and jet nozzle 42 may be varied and do not form part of the present invention.

The interior of the cooling jet housing 26 is hollow and defines a fluid chamber 34. A fluid inlet 44 is formed in the cylindrical side wall 28 of the cooling jet housing 26 as a generally rectangular aperture. A first abutment 46 is provided on the cylindrical side wall 28 near the first end wall 30. The first abutment 46 is in the general form of an increase in diameter of the cooling jet housing 26, to form a flange type formation. A second abutment 48 is provided near the second end wall 32. The second abutment 48 is similar in general form to the first abutment 46, being a general increase in diameter of the cooling jet housing 26, to form a flange type formation.

Two circumferential grooves 50 are provided on the cylindrical side wall 28. A mounting bracket 52 extends from one end of the piston cooling jet housing 26 adjacent to the first end wall 30. The circumferential grooves 50 receive O-rings (not shown). The cooling jets 40 are fitted into a cylinder block (not shown) of a reciprocating piston engine (not shown) in a manner that is known in the art by means of shafts in the cylinder block (not shown). The shafts extend perpendicular to the cylinders of the cylinder block (not shown). The piston cooling jets 22 are positioned in the shafts with the jet nozzles 38 directed toward the cylinders, one cooling jet 22 per shaft/cylinder. The piston cooling jets 22 are attached to the cylinder block by a bolt (not shown) that engages the mounting bracket 52. The mounting bracket 52 aids in positioning the jet nozzle 38, so the jet of coolant oil is directed at a desired location onto the underside of the reciprocating piston (not shown).

The piston cooling jets 40 are fed with coolant oil by a supply cavity (not shown), bored through the cylinder block perpendicular to the shafts (not shown). The supply cavity and individual shafts are in fluid communication. The O-rings (not shown) ensure a seal to impede oil escaping from a circuit defined by the shafts, cavity and cooling jets 40.

Industrial Applicability

One or more piston cooling jets 22 are provided within an internal combustion engine (not shown), generally one per cylinder. A supply of coolant oil is provided to the piston cooling jet 22 by the supply cavity (not shown) described above, the oil entering the fluid chamber 34 via the fluid inlet 44. As described above, the coolant oil will generally be taken directly from the engine sump and can therefore be contaminated by impurities and particulates. As the fluid passes through the filter element 10, the contaminants are reduced.

The filter element 10 requires periodic replacement or cleaning to maintain the efficiency of the system. In order to effect replacement or cracking of the filter element 10, the piston cooling jet 22 is first removed from the shaft in the cylinder block (not shown). When a filter element 10 is to be fitted onto the cooling jet 22, the filter element 10 is initially in its unfitted rest position with an associated rest diameter D1 as measured across its opposing ends (see FIG. 1). The opposing longitudinal edges 54, 56 are separated from each other by a rest spacing d1 in the rest position. The rest position will be understood to include the state in which at least part of the opposing longitudinal edges 54, 56 may be in contact such that the rest spacing is zero. Where the opposing longitudinal edges 54, 56 are physically spaced apart in the rest position, the rest spacing d1 will be smaller than the diameter or other minimum dimension of the perforations 14, so that the filter element does not permit the passage between the opposing longitudinal edges 54, 56 of particulates having a size greater than the permissible particulate size.

A torque is applied about axis 20 in the opposite direction to the direction of the filter element's helix to fit the filter element 10. This expands the filter element 10 until its diameter reaches a fitting diameter D2, as measured across its opposing ends (see FIG. 2). It is to be understood that the torque in this case is assumed to be applied manually, but the application of torque may also be mechanized or otherwise automated. With the filter element 10 in its expanded fitting position, the opposing longitudinal edges 54,56 are spaced apart from each other by a fitting spacing d2, which will be understood to be greater than the rest spacing d1.

The filter element 10 can then be placed over the cooling jet since its diameter will be sufficiently greater, and maneuvered between the first abutment 46 and the second abutment 48 over the cylindrical side wall 28. The torque acting on the filter element 10 is then released and the filter element 10 returns to a fitted rest position with an associated fitted rest diameter D3, with the opposing ends 16,18 abutting against the first abutment 46 and second abutment 48.

It will be understood that the fitted rest position may be the same as the unfitted rest position, such that D3=D1. However, the diameter of the side wall 28 may be such that D3 is slightly greater than D1, and the rest spacing d3 in the rest position is greater than the rest spacing d1 in the unfitted rest position. However, the rest spacing d3 will be smaller than the diameter or other minimum dimension of the perforations 14.

When the filter element 10 is to be replaced or removed for cleaning, torque is once again applied to the filter element 10 to open it to its fitting diameter D2. The filter element 10 is then taken off the piston cooling jet 22, and a new or a cleaned filter element 10 fitted in the manner mentioned above.

It is to be understood that the invention is not limited to the embodiment described, but may be varied in both construction and detail. For example, it is envisaged that the filter element could be constructed from any suitable filter material and is not limited to a perforated metal strip. The filter material could be of resilient plastic and a woven or non-woven mesh material could be used instead of perforations.

It is to be understood that even though the embodiments described herein relate particularly to piston cooling jet applications for internal combustion engines, the present invention could be applied to any appropriate fluid filtration system such as for example water filtration or air filtration.

The fluid flow may also be reversed, the fluid inlet being within the tubular filter and the fluid flowing radially outward and across the filter.

It is also to be understood that the invention is not limited to the embodiments hereinbefore described but may be modified in both construction and detail.

What is claimed is:

1. A filter element for a fluid filtration system, the filter element comprising a length of filter material arranged helically in a substantially tubular form, in which opposing longitudinal edges of the length are in facing relationship, the filter element being resiliently and selectively moveable from a rest position in which the opposing longitudinal edges are a rest spacing apart from each other, to an expanded position in which the opposing longitudinal edges are a fitting spacing apart from each other.

2. A filter element according to claim 1 wherein the filter material is a perforated strip.

3. A filter element according to claim 1 wherein the filter material is metal.

4. A filter element according to claim 2 wherein the filter material is metal.

5. A filter element according to claim 1 in which opposing ends of the length of filter material are shaped so that the tubular form is substantially cylindrical, in which each end of the tubular form defines a circle in a plane normal to a central axis of the tubular form.

6. A fluid filtration system comprising a fluid chamber having a fluid inlet and a fluid outlet, and a filter element according to claim 1, whereby the filter element in its rest position is arranged such that the filter material of the filter element covers one of said fluid inlet and fluid outlet.

7. A fluid filtration system according to claim 6 including a housing defining said fluid chamber, said housing having a substantially cylindrical wall portion in which is provided said one of said fluid inlet and fluid outlet wherein the filter element is arranged to surround said cylindrical wall portion.

8. A fluid filtration system according to claim 6 including first and second abutments provided to retain the filter element in the rest position.

9. A fluid filtration system according to claim 7 including first and second abutments provided to retain the filter element in the rest position.

10. A piston cooling jet arrangement for an internal combustion engine, comprising:
a piston cooling jet; and
a fluid filtration system according to claim 6 associated with said piston cooling jet.

11. A piston cooling jet arrangement for an internal combustion engine, comprising:
a piston cooling jet; and
a fluid filtration system according to claim 7 associated with said piston cooling jet.

12. A piston cooling jet arrangement for an internal combustion engine, comprising:
a piston cooling jet; and
a fluid filtration system according to claim 8 associated with said piston cooling jet.

13. A piston cooling jet arrangement for an internal combustion engine, comprising:
a piston cooling jet; and
a fluid filtration system according to claim 9 associated with said piston cooling jet.

14. A method of fitting a filter element on a fluid filtration system, wherein the filter element comprises a length of filter material arranged helically in a substantially tubular form, the method comprising the steps of:
expanding the filter element to an expanded fitting position in which opposing longitudinal edges of the length are a fitting spacing apart from each other by applying a torque around a central axis of the tubular form in an opposite direction to the filter material's helix;
fitting the filter element around a fluid chamber of the fluid filtration system; and
allowing the filter element to retract to a rest position surrounding the fluid chamber in which the opposing longitudinal edges of the length are a rest spacing apart from each other, so that the filter element covers a fluid inlet or fluid outlet of said fluid chamber.

15. A method of manufacturing a filter element comprising the steps of taking a substantially flat piece of filter material having a longitudinal axis, and winding it around a central axis to form a substantially tubular filter element in which the longitudinal axis of the flat piece of filter material is subsequently arranged substantially helically.

16. A filter element according to claim 1, wherein said filter element is manufactured by a process comprising the steps of taking a substantially flat piece of filter material having a longitudinal axis, and winding it around a central axis to form a substantially tubular filter element in which the longitudinal axis of the flat piece of filter material is subsequently arranged substantially helically.
